(19) United States
(12) Patent Application Publication
(10) Pub. No.: US 2015/0234055 A1
(43) Pub. Date: Aug. 20, 2015

(54) AERIAL AND CLOSE-RANGE PHOTOGRAMMETRY

(71) Applicant: JAVAD GNSS, Inc., San Jose, CA (US)

(72) Inventors: Javad ASHJAEE, Saratoga, CA (US); Mikhail DRAKIN, San Jose, CA (US)

(73) Assignee: JAVAD GNSS, Inc., San Jose, CA (US)

(21) Appl. No.: 14/185,803

(22) Filed: Feb. 20, 2014

(51) Int. Cl. G01S 19/42; G01C 11/02; G05D 1/00; B64C 19/00; B64D 47/08

(52) U.S. Cl. CPC G01S 19/42; B64C 19/00; B64D 47/08; G05D 1/0011; G01C 11/02

(57) ABSTRACT

Systems and methods for performing aerial photography and/or photogrammetry are provided. In one example, a path to be followed by an aerial vehicle may be generated based on a path traversed by a ground vehicle. The path to be followed by the aerial vehicle may be a path that is vertically and laterally offset from the path traversed by the ground vehicle. The path traversed by the ground vehicle may be transmitted by the ground vehicle to the aerial vehicle. Alternatively, the aerial vehicle may determine the path traversed by the ground vehicle by identifying the ground vehicle within images generated by the aerial vehicle. While the aerial vehicle traverses the path to be followed, the aerial vehicle may generate and store images of the ground or other points of interest. A photogrammetry process may be performed on an object of interest using the images generated by the aerial vehicle.

### BACKGROUND

1. Field

The present disclosure relates to Global Navigation Satellite System (GNSS) devices and, more specifically, to performing aerial and close-range photography or photogrammetry using a GNSS device.

2. Related Art

Photogrammetry refers to the science or technology of obtaining information (e.g., the geometry, position, or the like) about objects based on their images. One type of photogrammetry known as “close-range photogrammetry” includes obtaining images of an object and performing analyses on those images to determine the geometry of the object. While useful for obtaining information about the object, current photogrammetry techniques require the use of specialized cameras and/or other hardware to obtain precise geo-referenced results.

Another type of photogrammetry known as “aerial photogrammetry” includes the use of unmanned aerial vehicles, such as helicopters, planes, or the like, that are equipped with one or more cameras to capture images from the vehicle and one or more navigation receivers to determine the location of the vehicle. The navigation receivers may use global navigation satellite systems, such as GPS or GLONASS (hereinafter collectively referred to as “GNSS”), to enable a highly accurate determination of the position of the receiver. The satellite signals may comprise carrier signals that are modulated by pseudo-random binary codes and that, on the receiver side, may be used to measure the delay relative to a local reference clock. These delay measurements may be used to determine the pseudo-ranges between the receiver and the satellites. The pseudo-ranges are not true geometric ranges because the receiver's local clock may be different from the satellite onboard clocks. If the number of satellites in sight is greater than or equal to four, then the measured pseudo-ranges may be processed to determine the user's single point location as represented by a vector X=(x,y,z)^{T}, as well as to compensate for the receiver clock offset.

The images captured by the unmanned aerial vehicles, along with location information associated with the images, may be processed to determine information about the area photographed by the aerial vehicles. While the unmanned aerial vehicles may be used to capture images of locations that may be otherwise difficult to access, conventional unmanned aerial vehicles must be operated manually by a pilot using a remote control system or must be configured to follow a pre-programmed path (e.g., that was entered using mission planning software).

### BRIEF SUMMARY

Systems and methods for performing aerial photography and/or photogrammetry are provided. In one example, a path to be followed by an aerial vehicle may be generated based on a path traversed by a ground vehicle. The path to be followed by the aerial vehicle may be a path that is vertically and laterally offset from the path traversed by the ground vehicle. The path traversed by the ground vehicle may be transmitted by the ground vehicle to the aerial vehicle. Alternatively, the aerial vehicle may determine the path traversed by the ground vehicle by identifying the ground vehicle within images generated by the aerial vehicle. While the aerial vehicle traverses the path to be followed, the aerial vehicle may generate and store images of the ground or other points of interest. A photogrammetry process may be performed on an object of interest using the images generated by the aerial vehicle.

### BRIEF DESCRIPTION OF THE DRAWINGS

FIG. 1 illustrates an exemplary system block diagram of a ground vehicle and an unmanned aerial vehicle according to various examples.

FIG. 2 illustrates an exemplary GNSS receiver and computing system according to various examples.

FIG. 3 illustrates an exemplary process for navigating a path to be followed by an unmanned aerial vehicle and for performing aerial photography and/or photogrammetry according to various examples.

FIG. 4 illustrates an exemplary process for generating a path to be followed by an unmanned aerial vehicle according to various examples.

FIG. 5 illustrates a side view of a ground vehicle and an offset location that may be added to a path to be followed by an unmanned aerial vehicle according to various examples.

FIG. 6 illustrates a top view of a ground vehicle and an offset location that may be added to a path to be followed by an unmanned aerial vehicle according to various examples.

FIG. 7 illustrates another exemplary process for generating a path to be followed by an unmanned aerial vehicle according to various examples.

FIG. 8 illustrates an exemplary process for performing photogrammetry according to various examples.

FIG. 9 illustrates a system diagram of an exemplary handheld GNSS device that may be used to perform the photogrammetry process of FIG. 8.

FIG. 10 illustrates an overhead view of the handheld GNSS device of FIG. 9 being used to perform the photogrammetry process of FIG. 8.

FIGS. 11-13 illustrate example user interfaces that may be displayed by the handheld GNSS device of FIG. 9.

In the following description, reference is made to the accompanying drawings which form a part thereof, and which illustrate several embodiments of the present disclosure. It is understood that other embodiments may be utilized and structural and operational changes may be made without departing from the scope of the present disclosure. The use of the same reference symbols in different drawings indicates similar or identical items.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention as claimed. Thus, the various embodiments are not intended to be limited to the examples described herein and shown, but are to be accorded the scope consistent with the claims.

Systems and methods for performing aerial photography and/or photogrammetry are provided. In one example method, a path to be followed by an aerial vehicle may be generated based on a path traversed by a ground vehicle. The path to be followed by the aerial vehicle may be a path that is vertically and laterally offset from the path traversed by the ground vehicle. In some examples, the path traversed by the ground vehicle may be transmitted by the ground vehicle to the aerial vehicle. In other examples, the aerial vehicle may determine the path traversed by the ground vehicle by identifying the ground vehicle within images generated by the aerial vehicle. While the aerial vehicle traverses the path to be followed, the aerial vehicle may generate and store images of the ground or other points of interest. In some examples, a photogrammetry process may be performed on an object of interest using the images generated by the aerial vehicle.

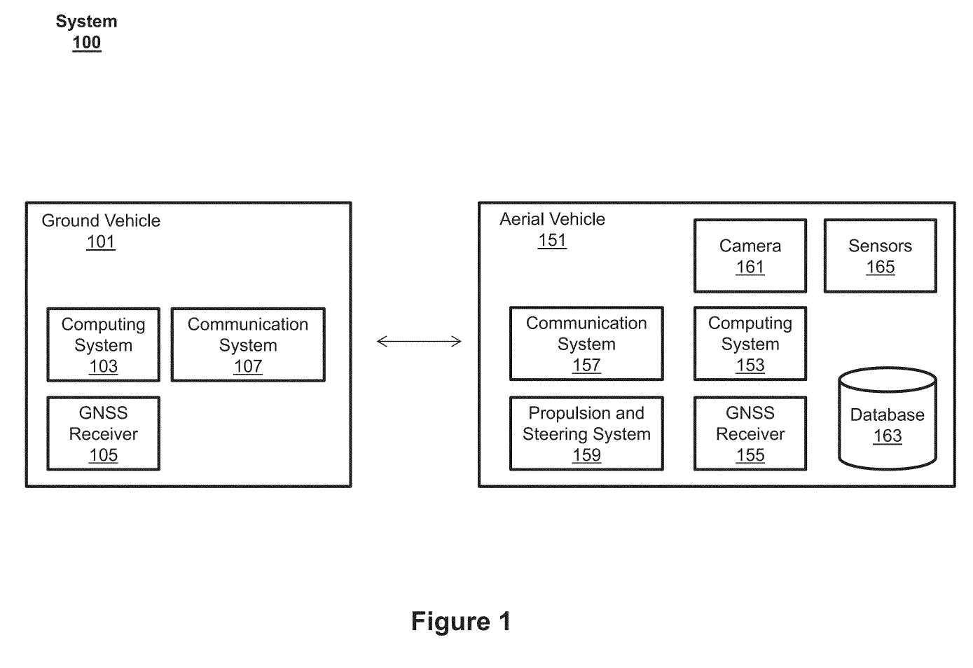

FIG. 1 illustrates a block diagram of an example system 100 for performing aerial photography or photogrammetry according to various examples. System 100 may generally include a ground vehicle 101, such as a car, truck, van, or the like, and an unmanned aerial vehicle 151, such as a plane, helicopter, or the like. In operation, ground vehicle 101 may be driven on or near a path to be photographed by aerial vehicle 151, which may be configured to follow an offset path that is vertically and, in some examples, also horizontally offset from the path driven by ground vehicle 101.

As shown in FIG. 1, ground vehicle 101 may include a GNSS receiver 105 for receiving GNSS satellite signals and processing those signals to determine a location of ground vehicle 101 expressed in any desired coordinate system (e.g., WGS-84, ECEF, ENU, NAD-85, or the like). GNSS receiver 105 may be communicatively coupled to computing system 103 to provide computing system 103 with the converted system coordinates and/or the received GNSS signals for processing. Computing system 103 may be configured to cause the received coordinates (or coordinates determined by computing system 103 by processing the received GNSS signals) to be transmitted to aerial vehicle 151 via communication system 107. Computing system 103 may be configured to cause the coordinates of ground vehicle 101 to be transmitted to aerial vehicle 151 at any desired interval or frequency (e.g., twice per second, once per second, once per 5 seconds, or the like). Communication system 107 may include communication circuitry to support any desired wireless communication technology, such as radio, WiFi, cellular, or the like.

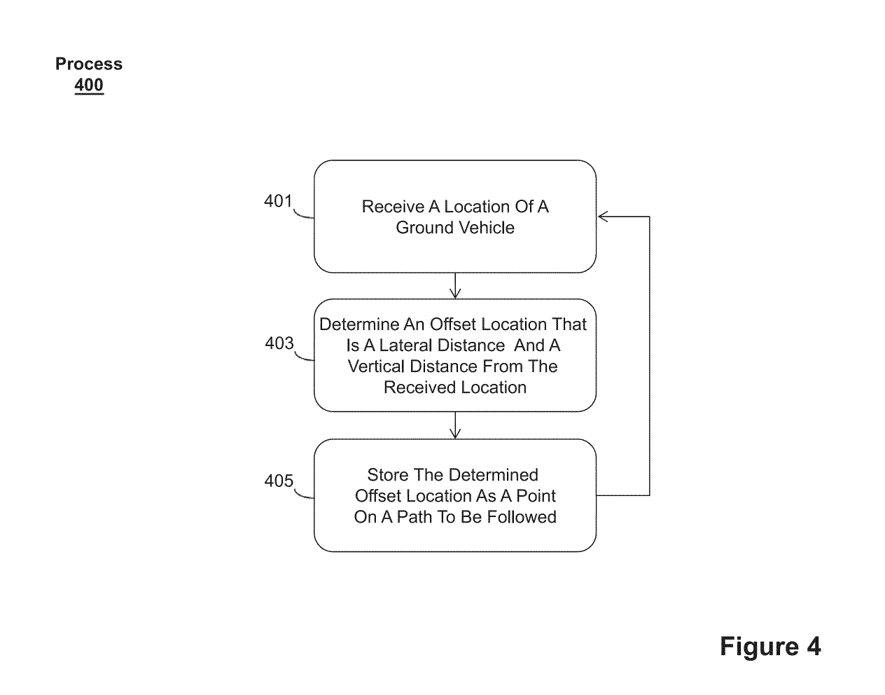

Aerial vehicle 151 may include communication system 157, which may be similar or identical to communication system 107, communicatively coupled to receive the transmitted coordinates from communication system 107. Communication system 157 may be coupled to provide the received coordinates of ground vehicle 101 to computing system 153. As discussed in greater detail below with respect to FIG. 4, computing system 153 may be configured to store the received coordinates of ground vehicle 101 as points on a path in database 163, and may be configured to use the stored path to navigate an offset path that is vertically and, in some examples, also horizontally offset from the path driven by ground vehicle 101.

Aerial vehicle 151 may further include GNSS receiver 155, which may be similar or identical to GNSS receiver 105, for receiving GNSS satellite signals and processing those signals to determine a location of aerial vehicle 151 expressed in any desired coordinate system (e.g., WGS-84, ECEF, ENU, NAD-85, or the like). Computing system 153 may be coupled to receive the converted system coordinates and/or the received GNSS signals for processing from GNSS receiver 155. In some examples, the converted system coordinates and/or the GNSS signals received from GNSS receiver 155 may be transmitted to ground vehicle 101 via communication system 157. In other examples, the converted system coordinates and/or the GNSS signals received from GNSS receiver 155 may be used by computing system 153 for navigation and/or may be stored in database 163.

Aerial vehicle may further include sensors 165 for assisting computing system 153 with the leveling and navigation of aerial vehicle 151. Sensors 165 may include any number of gyroscopes, inclinometers, accelerometers, compasses, or the like, positioned on or within aerial vehicle 151. The data generated by sensors 165 may be provided to computing system 153, which may use the sensor data and converted system coordinates and/or the received GNSS signals from GNSS receiver 155 to navigate aerial vehicle 151 along the offset path stored in database 163.

Computing system 153 may be further coupled to control propulsion and steering system 159 to cause aerial vehicle 151 to move in a desired manner. Propulsion and steering system 159 may include conventional components for propelling and steering an aerial vehicle (e.g., a plane, helicopter, or the like), such as a motor, propeller, rotor, rudder, ailerons, or the like. Computing system 153 may be configured to control the components of propulsion and steering system 159 to cause aerial vehicle 151 to traverse the offset path stored in database 163 using data received from sensors 165, GNSS receiver 155, and communication system 157.

Aerial vehicle 151 may further include one or more cameras 161 coupled to computing system 153. Cameras 161 may include any number of still or video cameras for capturing images or video as viewed from aerial vehicle 151. In some examples, cameras 161 may be attached to a bottom side of aerial vehicle 151 such that cameras 161 are positioned to capture images or video of objects located below aerial vehicle 151 when operated in a normal manner. In other examples, cameras 161 may be fixed to aerial 151 by a rotatable mount, allowing computing system 153 to control a direction of cameras 161. During operation, computing system 153 may be configured to cause cameras 161 to capture images or video at any desired time, interval, frequency, or the like. The image data generated by cameras 161 may be stored in database 163.

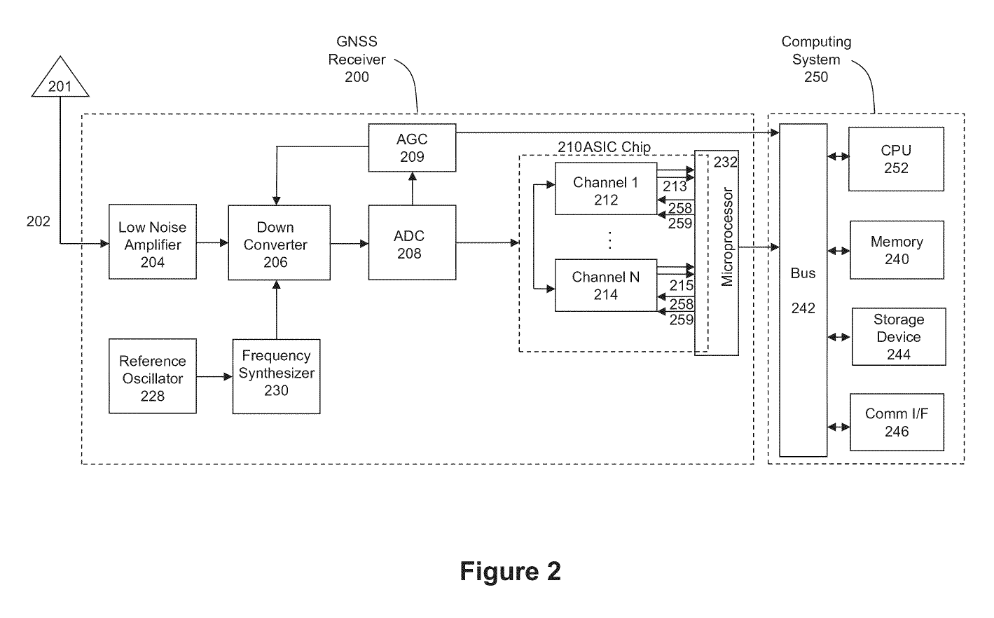

FIG. 2 illustrates an exemplary GNSS receiver 200 that may be used to implement GNSS receivers 105 and 155 of system 100. GNSS receiver 200 may receive GNSS signals 202 via a GNSS antenna 201. GNSS signal 202 may contain two pseudo-noise (“PN”) code components, a coarse code, and a precision code residing on orthogonal carrier components, which may be used by GNSS receiver 200 to determine the position of the GNSS receiver. For example, a typical GNSS signal 202 may include a carrier signal modulated by two PN code components. The frequency of the carrier signal may be satellite specific. Thus, each GNSS satellite may transmit a GNSS signal at a different frequency.

GNSS receiver 200 may also contain a low noise amplifier 204, a reference oscillator 228, a frequency synthesizer 230, a down converter 206, an automatic gain control (AGC) 209, and an analog-to-digital converter (ADC) 208. These components may perform amplification, filtering, frequency down-conversion, and sampling. The reference oscillator 228 and frequency synthesizer 230 may generate a frequency signal to down convert the GNSS signals 202 to baseband or to an intermediate frequency depending on the entire receiver frequency plan design and available electronic components. The ADC 208 may then converts the GNSS signals 202 to a digital signal by sampling multiple repetitions of the GNSS signals 202.

The GNSS receiver 200 may further include multiple GNSS channels, such as channels 212 and 214. It should be understood that any number of channels may be provided. The GNSS channels 212 and 214 may each contain a demodulator to demodulate a GNSS PN code contained in ADC signal 209, a PN code reference generator, a numerically controlled oscillator (code NCO) to drive the PN code generator as well as a carrier frequency demodulator (e.g., a phase detector of a phase locked loop—PLL), and a numerically controlled oscillator to form a reference carrier frequency and phase (carrier NCO). In one example, the numerically controlled oscillator (code NCO) of channels 212 and 214 may receive code frequency/phase control signal 258 as input. Further, the numerically controlled oscillator (carrier NCO) of channels 212 and 214 may receive carrier frequency/phase control signal 259 as input.

In one example, the processing circuitry for the GNSS channels may reside in an application specific integrated circuit (“ASIC”) chip 210. When a corresponding frequency is detected, the appropriate GNSS channel may use the embedded PN code to determine the distance of the receiver from the satellite. This information may be provided by GNSS channels 212 and 214 through channel output vectors 213 and 215, respectively. Channel output vectors 213 and 215 may each contain four signals forming two vectors—inphase I and quadriphase Q which are averaged signals of the phase loop discriminator (demodulator) output, and inphase dl and quadriphase dQ—averaged signals of the code loop discriminator (demodulator) output.

In some examples, a computing system 250 may be coupled to receive position information (e.g., in the form of channel output vectors 213 and 215 or any other representation of position) from GNSS receiver 200. Computing system 250 may be used to implement computing system 103 or 153. Computing system 250 may include processor-executable instructions for performing aerial photography or photogrammetry stored in memory 240. The instructions may be executable by one or more processors, such as a CPU 252. However, those skilled in the relevant art will also recognize how to implement the current technology using other computer systems or architectures. CPU 252 may be implemented using a general or special purpose processing engine such as, for example, a microprocessor, microcontroller or other control logic. In this example, CPU 252 is connected to a bus 242 or other communication medium.

Memory 240 may include read only memory (“ROM”) or other static storage device coupled to bus 242 for storing static information and instructions for CPU 252. Memory 240 may also include random access memory (RAM) or other dynamic memory, for storing information and instructions to be executed by CPU 252. Memory 240 may also be used for storing temporary variables or other intermediate information during execution of instructions to be executed by CPU 252.

Computing system 250 may further include an information storage device 244 coupled to bus 242. The information storage device may include, for example, a media drive (not shown) and a removable storage interface (not shown). The media drive may include a drive or other mechanism to support fixed or removable storage media, such as a hard disk drive, a floppy disk drive, a magnetic tape drive, an optical disk drive, a CD or DVD drive (R or RW), or other removable or fixed media drive. Storage media may include, for example, a hard disk, floppy disk, magnetic tape, optical disk, CD or DVD, or other fixed or removable medium that is read by and written to by media drive. As these examples illustrate, the storage media may include a non-transitory computer-readable storage medium having stored therein particular computer software or data.

In other examples, information storage device 244 may include other similar instrumentalities for allowing computer programs or other instructions or data to be loaded into computing system 250. Such instrumentalities may include, for example, a removable storage unit (not shown) and an interface (not shown), such as a program cartridge and cartridge interface, a removable memory (e.g., a flash memory or other removable memory module) and memory slot, and other removable storage units and interfaces that allow software and data to be transferred from the removable storage unit to computing system 250.

Computing system 250 may further include a communications interface 246. Communications interface 246 may be used to allow software and data to be transferred between computing system 250 and external devices. Examples of communications interface 246 may include a modem, a network interface (such as an Ethernet or other NIC card), a communications port (such as for example, a USB port), a PCMCIA slot and card, etc. Software and data transferred via communications interface 246. Some examples of a communication interface 246 include a phone line, a cellular phone link, an RF link, a network interface, a local or wide area network, and other communications channels.

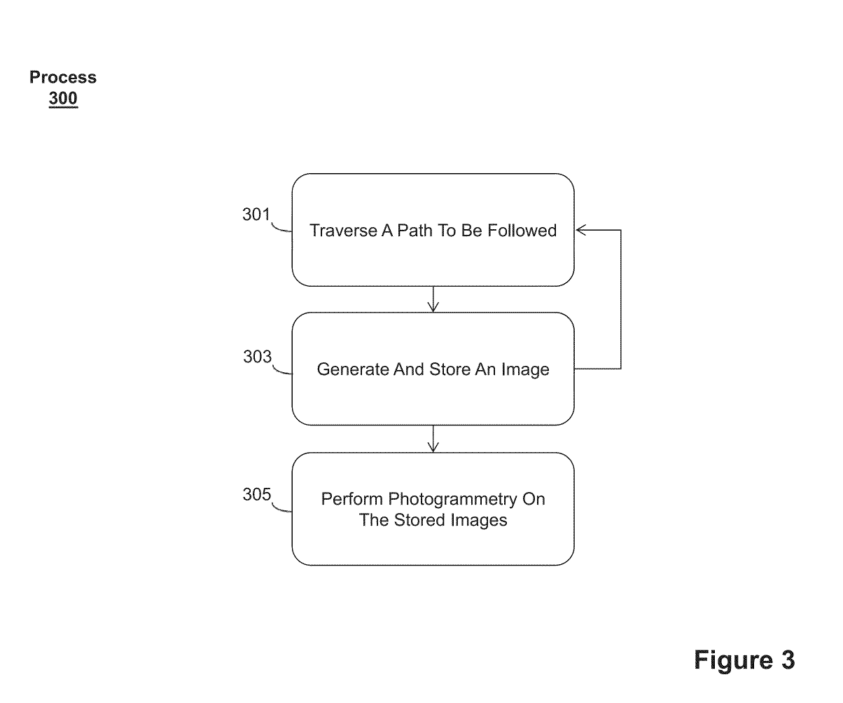

FIG. 3 illustrates an exemplary process 300 for performing aerial photography or photogrammetry using a system similar or identical to system 100. At block 301, an aerial vehicle may traverse a path that is to be followed by the aerial vehicle. The path may include any number of sequentially ordered points, where each point represents a location expressed in any desired coordinate system, such WGS-84, ECEF, ENU, NAD-85, or the like. The aerial vehicle may traverse the path by traveling to the first point in the path (or within a threshold distance of the point), and subsequently traveling to each of the remaining sequentially ordered points in the order in which they are arranged in the path. This traversal may be performed automatically without a user instructing the aerial vehicle to navigate in a particular manner.

In some examples, an aerial vehicle similar or identical to aerial vehicle 151 may be used to traverse a path to be followed at block 301. In these examples, the path and the points that make up the path may be stored in database 163 of aerial vehicle 151. To traverse the stored path, computing system 153 may determine a current location of the aerial vehicle using GNSS receiver 155, determine a direction to the next point in the stored path, and control the propulsion and steering system 159 to cause aerial vehicle 151 to travel towards the next point in the path. This process may be repeated until the aerial vehicle, as determined by GNSS receiver 155, reaches the location of the point (or within a threshold distance of the point). Upon reaching the point, the next sequentially ordered point in the path may be assigned as the next point, and computing system 153 may repeat the process to travel toward the (new) next point in the path. This process may be repeated until the aerial vehicle has sequentially navigated to all points in the path.

In some examples, the path may be generated or expanded (e.g., points added to the path) dynamically while the aerial vehicle traverses the path at block 301. Additionally, the path may be generated with reference to the location and movement of a ground vehicle similar or identical to ground vehicle 101 such that the path to be traveled by the aerial vehicle is offset by a vertical and/or horizontal distance from the path traveled by the ground vehicle. In this way, operators may navigate the ground vehicle along a path for which they would like images, and the aerial vehicle may follow the ground vehicle on a path that is offset by a vertical and/or horizontal distance to generate the desired images. FIGS. 4-7 illustrate two exemplary processes that may be performed to generate a path to be followed by an aerial vehicle at block 301 of process 300.

FIG. 4 illustrates a first exemplary process 400 that may be used to generate a path to be followed by an aerial vehicle at block 301 of process 300. At block 401, a location of a ground vehicle may be received by an aerial vehicle. For example, an aerial vehicle similar or identical to aerial vehicle 151 may wirelessly receive a location of a ground vehicle similar or identical to ground vehicle 101 via communication systems 107 and 157. The location of the ground vehicle may be determined using a GNSS receiver similar or identical to GNSS receiver 105 and may be expressed in any desired coordinate system, such WGS-84, ECEF, ENU, NAD-85, or the like.

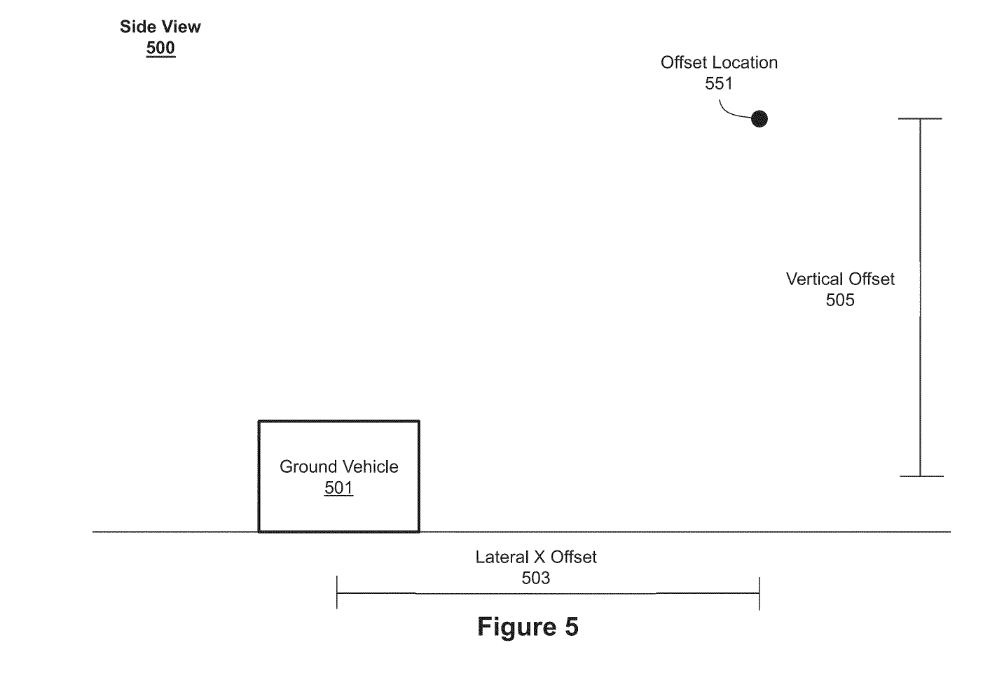

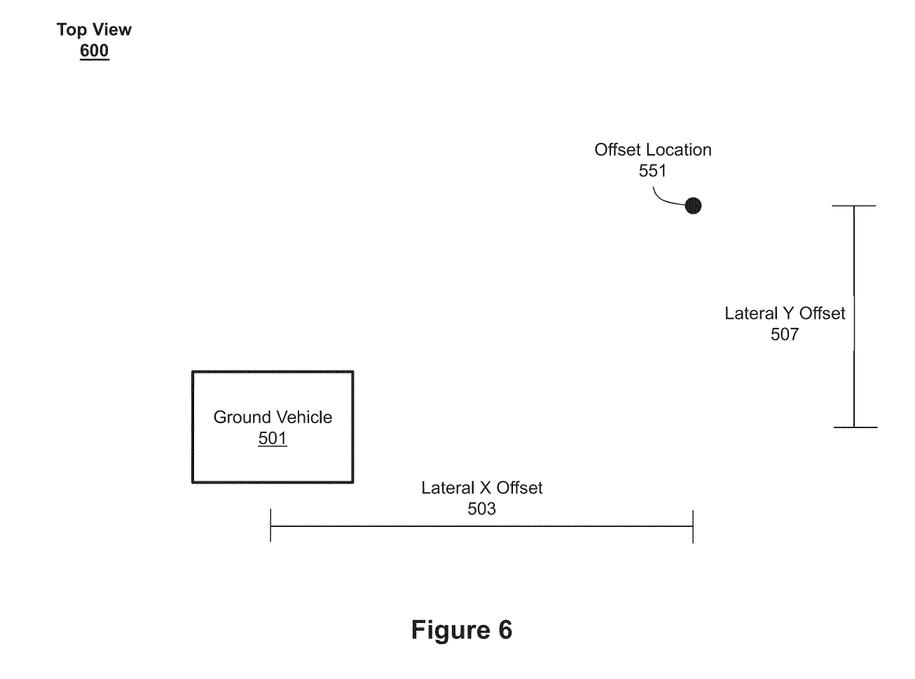

At block 403, an offset location that is a predetermined lateral distance and a predetermined vertical distance away from the location of the ground vehicle received at block 301 may be determined. The predetermined lateral and vertical distances may be any zero or non-zero value. For example, if the aerial vehicle is to follow above the path traveled by the ground vehicle, the lateral distance may be set to zero and the vertical distance may be set to 200 meters. In some examples, when using an aerial vehicle similar or identical to aerial vehicle 151, the offset location may be determined by computing system 153 by subtracting (or adding) lateral and vertical distances to the three-dimensional location of the ground vehicle received at block 301. To illustrate, FIG. 5 shows a side view 500 of ground vehicle 501 and offset location 551 that is a predetermined lateral X offset distance 503 and a predetermined vertical offset distance 505 from the position of ground vehicle 501 (e.g., received at block 401). FIG. 6 shows a top view 600 of ground vehicle 501 and offset location 551 that is the predetermined lateral X offset distance 503 and a predetermined lateral Y offset distance 507 from the position of ground vehicle 501 (e.g., received at block 401). In the illustrated example, offset location 551 may be determined by identifying a point that is a lateral X offset distance 503, lateral Y offset distance 507, and vertical offset distance 505 from the position of ground vehicle 501 received at block 401 of process 400.

Returning to FIG. 4, at block 405, the offset location determined at block 403 may be stored as point on a path to be followed by the aerial vehicle. The path may include any number of sequentially ordered points, where each point represents a location expressed in any desired coordinate system, such WGS-84, ECEF, ENU, NAD-85, or the like. As discussed above with respect to FIG. 3, the aerial vehicle may traverse the path by traveling to the first point in the path (or within a threshold distance of the point), and subsequently traveling to each of the remaining sequentially ordered points in the order in which they are arranged in the path. If the path does not include any points (e.g., if the offset location determined at block 403 is the first point to be added to the path), then the offset location may be added to the path as the first point in the path. If, however, the path includes one or more points, then the offset location determined at block 403 may be appended to the current last point in the path (and will subsequently become the new current last point in the path). In some examples, when using an aerial vehicle similar or identical to aerial vehicle 151, the path may be stored in database 163 and computing system 153 may cause the offset location determined at block 403 to be stored in database 163 at block 405.

The process may return to block 401, where the aerial vehicle may receive another location of the ground vehicle. Blocks 401, 403, and 405 may be repeated any number of times with any desired frequency. For example, the ground vehicle may transmit its location once every second (or any other desired length of time) and that location may be received by the aerial vehicle at block 401. The received location of the ground vehicle may be used by the aerial vehicle to determine an offset location at block 403 and the offset location may be stored as a point on a path to be followed at block 405. This sequence of blocks 401, 403, and 405 may be repeated each time the ground vehicle transmits its location to the aerial vehicle.

In alternative examples, the offset location may instead be determined by the ground vehicle and the determined offset location may be transmitted to the aerial vehicle and received by the aerial vehicle at block 401. For example, a ground vehicle similar or identical to ground vehicle 101 may determine its current location using GNSS receiver 105, determine an offset location that is a predetermined lateral and/or vertical distance from the current location using computing system 103, and transmit the determined offset location to aerial vehicle 151 using communication system 107. The determined offset location may be received by aerial vehicle 151 via communication system 157 at block 401. In these examples, block 403 may be omitted and the offset location received at block 401 may be stored in database 163 as a point on a path to be followed by the aerial vehicle at block 405.

While process 400 is described above using absolute positions for the ground vehicle and the aerial vehicle, it should be appreciated that relative positioning may also be used by using the ground vehicle as a base and the aerial vehicle as a rover. In these examples, relative positions between the vehicles may be computed and used to generate and update the path to be followed by the aerial vehicle.

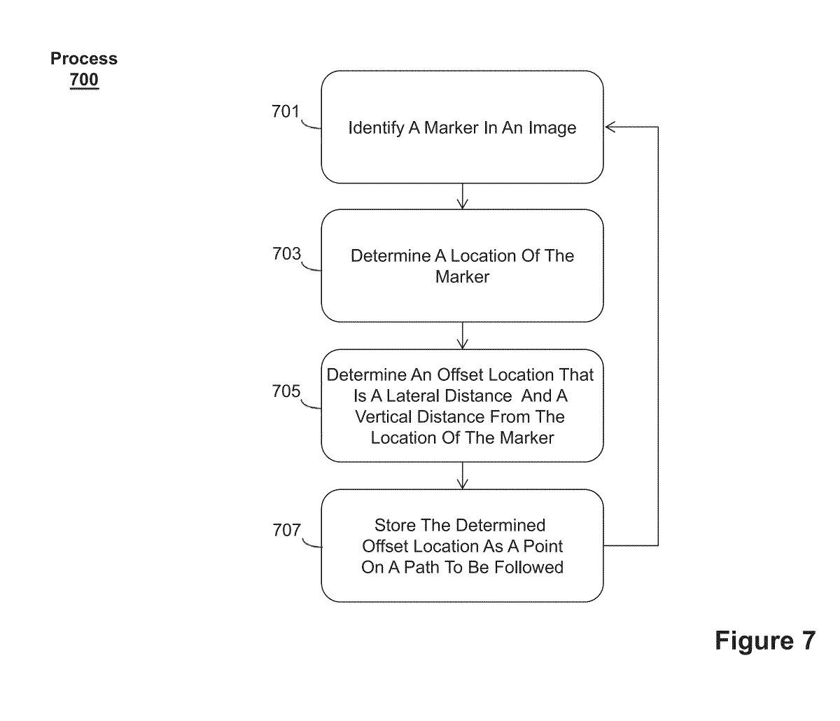

FIG. 7 illustrates a second exemplary process 700 that may be used to generate a path to be followed by an aerial vehicle at block 301 of process 300. At block 701, an image as viewed from the aerial vehicle may be obtained and a marker (e.g., positioned on the top of a ground vehicle similar or identical to ground vehicle 101) may be identified within the image. The marker may be identified by its shape, color, or the like (or combinations thereof). For example, an aerial vehicle similar or identical to aerial vehicle 151 may generate an image of a view from the aerial vehicle facing towards the ground. Computing system 153 may analyze the image to identify a marker within the image having a predetermined shape, size, or the like (or combinations thereof).

At block 703, the aerial vehicle may determine a location of the marker. In some examples, an aerial vehicle similar or identical to aerial vehicle 151 may determine the location of the marker using computing system 153 based on a location of camera 161 (e.g., determined using a location determined by GNSS receiver 155 and the separation between camera 161 and GNSS receiver 155), an orientation of camera 161 at the time the image was generated (e.g., based on the orientation of aerial vehicle 151 determined by sensors 165 and an orientation difference between the optical axis of camera 161 and sensors 165), an angle between an optical axis of camera 161 and the marker (e.g., estimated based on a position of the marker relative to the center of the image generated by camera 161), and an estimated distance between camera 161 and the marker (e.g., based on a size of the marker within the image). For example, by combining the orientation of camera 161 with the angle between an optical axis of camera 161 and the marker, an angle formed between a vertical line passing through aerial vehicle 151 and a line passing through the marker and aerial vehicle 151 may be determined. The position of the marker may then be estimated based on the location of camera 161 and the distance between camera 161 and the marker.

At block 705, an offset location that is a predetermined lateral distance and a predetermined vertical distance away from the location of the marker determined at block 703 may be determined. The predetermined lateral and vertical distances may be any zero or non-zero value. The process for determining the offset location may be the same as described above with respect to block 403 of process 400.

At block 707, the offset location determined at block 705 may be stored as point on a path to be followed by the aerial vehicle in a manner similar or identical to that described above with respect to block 405 of process 400.

Referring back to FIG. 3, while traversing and generating the path to be followed at block 301, block 303 may also be performed periodically (or at any other desired frequency or interval) to generate and store an image as viewed from the aerial vehicle at block 303. For example, using an aerial vehicle similar or identical to aerial vehicle 151, computing system 153 may be configured to cause camera 161 to generate an image at a desired frequency. The images may be received by computing system 153 and stored in database 163. The time when, and location where (e.g., as determined by GNSS receiver 155), each image was generated by camera 161 may be stored along with the images in database 163. In some examples, the frequency at which camera 161 generates an image may depend on the field of view of camera 161 and a speed at which aerial vehicle 151 is traveling. In these examples, the frequency may be selected such that the images captured by camera 161 at least partially overlap with a previously and subsequently generated image. In this way, aerial vehicle 151 may generate images that map the area below or near the path of aerial vehicle 151.

When using process 400 to generate a path to be followed by an aerial vehicle at block 301, blocks 301 and 303 may sequentially or concurrently be performed to cause the aerial vehicle to fly along an offset path similar (offset by a vertical and/or lateral distance) to that traversed by a ground vehicle operated by a user and to generate images of the area below or near the offset path. For example, if a user wants to generate overhead images of an area that runs parallel and 150 meters to the east of a road, the user may configure the aerial vehicle to travel along an offset path that is 200 meters above and 150 meters east of the path traveled by the ground vehicle. The user may then activate the aerial vehicle and begin driving the ground vehicle along the road. As the ground vehicle travels along the road, the ground vehicle may transmit its position to the aerial vehicle, which may perform processes 300 and 400 to fly along the offset path that is 200 meters above and 150 meters east of the path traveled by the ground vehicle and may generate and store images of the path as viewed from above. Upon navigating the desired portion of the road, a command may be transmitted from the ground vehicle to the aerial vehicle to cause the aerial vehicle to return to the position of the ground vehicle.

When using process 700 to generate a path to be followed by an aerial vehicle at block 301, blocks 301 and 303 may sequentially or concurrently be performed to cause the aerial vehicle to fly along an offset path similar (offset by a vertical and/or lateral distance) to that traversed by a ground vehicle operated by a user and to generate images of the area below or near the offset path. For example, if a user wants to generate overhead images of a road, the user may configure the aerial vehicle to travel along an offset path that is 200 meters above the path traveled by the ground vehicle. The ground vehicle may be equipped with a marker, such as a circle having a distinct color, on the roof of the vehicle. The user may then activate the aerial vehicle and begin driving the ground vehicle along the road. As the ground vehicle travels along the road, the aerial vehicle may perform processes 300 and 700 to track the location of the ground vehicle, fly along the offset path that is 200 meters above the path traveled by the ground vehicle, and generate and store images of the path as viewed from above. Upon navigating the desired portion of the road, a command may be transmitted from the ground vehicle to the aerial vehicle to cause the aerial vehicle to return to the position of the ground vehicle.

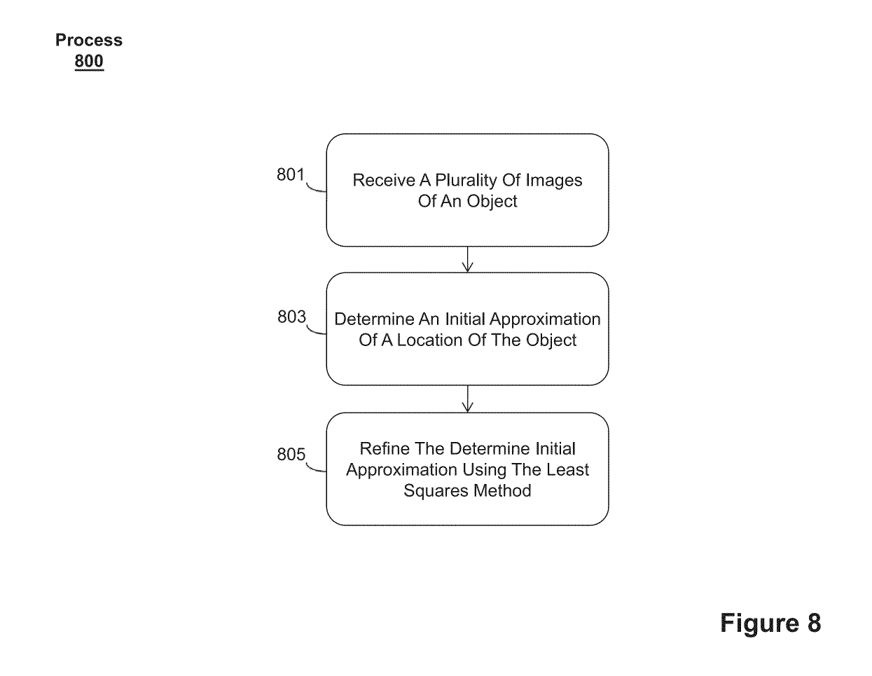

In some examples, process 300 may further include performing a photogrammetry process at block 305 on the images generated and stored by the aerial vehicle at block 303. FIG. 8 illustrates an exemplary process 800 that may be used to perform photogrammetry at block 305. At block 801, a plurality of images of an object of interest may be received. The plurality of images may include some or all of the images generated and stored at block 303 of process 300, which may include images that were generated at different locations and may show a view of the object from different angles. The images may further include associated metadata that identifies a location and orientation at which the image was generated (e.g., location of the camera and the orientation of the optical axis of the camera). The location for each image may be represented using any desired coordinate system and may be determined using a GNSS receiver (e.g., GNSS receiver 155) and a known separation between the GNSS receiver and an optical sensor of the camera used to generate the image. The orientation at which the image was generated may be determined using sensors, such as gyroscopes, inclinometers, compasses, or the like (e.g., sensors 165) and known angle differences between the sensors and the optical axis of the camera.

At blocks 803 and 805, a bundle adjustment process may be performed on the plurality of images received at block 801 to determine a location of the object of interest. Generally, the bundle adjustment process may include determining an initial approximation of the location of the object at block 803 and refining the initial approximation using the least squares method at block 805.

In some examples, determining an initial approximation of the location of the object at block 803 may include a direct method that approximates the location of the object by identifying an intersection between lines pointing towards the object of interest that originate from the locations that the images were captured. This may include identifying the object of interest within two or more of the plurality of images using known image recognition techniques, such as by identifying the object of interest based on colors, shapes, a combination thereof, or the like. For each of these images, a mathematical representation of a line pointing towards the object of interest that originates from the location that the image was captured may be generated. The locations at which the images were captured may be determined from the metadata associated with the images (e.g., determined using a GNSS receiver as discussed above). The directions of the lines pointing towards the object of interest may be determined by identifying an angle between an optical axis of the camera (which may have been determined using orientation sensors and stored as metadata associated with each image) and the object of interest in the images. Determining the angle between the optical axis and the object of interest may be based on the principle that each pixel of the image represents an angle from the camera optical axis. For example, the pixel at the center of an image may represent the optical axis, while a pixel 5 pixels to the right of center may represent a particular angle to the right of optical axis. By knowing the pixel coordinates of the object of interest in each image, the direction to this object from camera optical axis may be determined. Using these determined locations and orientations, the lines pointing towards the object of interest and originating from the locations that the images were captured may be generated. An intersection between these generated lines may be determined and as used as the initial approximation of the location of the object.

At block 805, the initial approximation determined at block 803 may be refined using a least squares method. For example, block 805 may include using the least squares method to refine the coordinates of all objects, camera axes, orientations, and the like, as a single system of equations relating objects' coordinates and scene parameters to resulting pixel coordinates on all images. The refined approximation resulting from block 805 may represent the determined position of the object of interest.

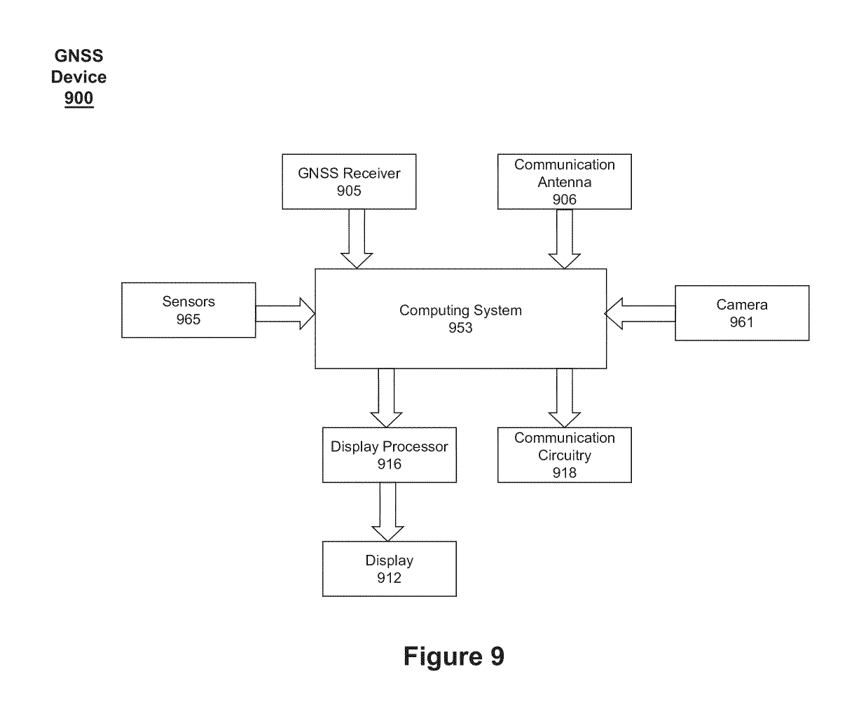

While one example bundle adjustment process is provided above, it should be appreciated that other variations of a bundle adjustment process may be used to determine a location of a point of interest using multiple images. Additionally, while process 800 is described above as being used to perform photogrammetry on images generated by an aerial vehicle, it should be appreciated that process 800 may similarly be used on images generated by a handheld GNSS device. For example, FIG. 9 illustrates a system block diagram showing the relationships between various components of an exemplary handheld GNSS device 900 that may generate the images used by process 800

GNSS device 900 may include GNSS receiver 905, which may be similar or identical to GNSS receiver 200, for receiving GNSS satellite signals and processing those signals to determine a location of GNSS device 900 expressed in any desired coordinate system (e.g., WGS-84, ECEF, ENU, NAD-85, or the like). GNSS receiver 905 may be coupled to provide the converted system coordinates and/or the received GNSS signals for processing to computing system 953, which may be similar or identical to computing system 103 or 153.

GNSS device 900 may further include sensors 965 for determining an orientation of the GNSS device 900. Sensors 965 may be similar or identical to sensors 165, and may include any number of gyroscopes, inclinometers, accelerometers, compasses, or the like. Sensors 965 may be coupled to provide orientation data to computing system 953. GNSS device 900 may further include one or more cameras 961, which may be similar or identical to camera 161, coupled to computing system 953. Cameras 961 may include any number of still or video cameras for capturing images or video as viewed from GNSS device 900. In some examples, GNSS device 900 may further include display 912 controlled by display processor 916 for displaying a control interface for the device and images generated by camera 961.

In some examples, GNSS device 900 may include communication antenna 906 for receiving position assistance data, which may be used along with the position data received from GNSS receiver 905 to determine a position of GNSS device 900. A more detailed description of an example portable GNSS device that may be used for GNSS device 900 is provided in U.S. Pat. No. 8,125,376 and U.S. Patent Publication No. 2012/0299936, which are assigned to the assignee of the present disclosure, and which are incorporated herein by reference in their entirety for all purposes.

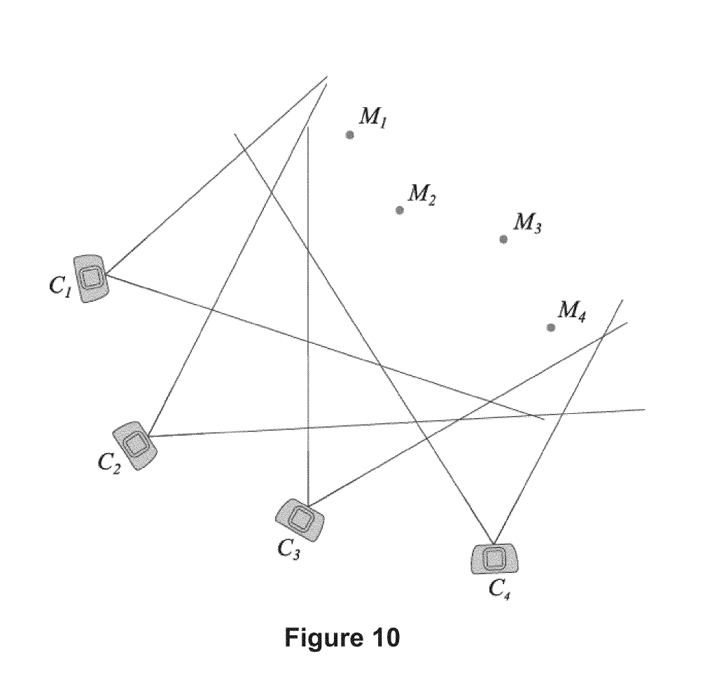

Similar to aerial vehicle 151, GNSS device 900 may be used to generate images of an object of interest from different locations and at different orientations. FIG. 10 illustrates an overhead view of four different locations C1, C2, C3, and C4 of GNSS device 900 as it generates images of objects of interest M1, M2, M3, and M4. GNSS device 900 may store the images generated at each location along with the location and orientation at which the images were generated. For example, the location at which the image was generated may be determined using the position as determined by GNSS receiver 905 and a known separation between GNSS receiver 905 and an optical sensor of camera 961. The orientation at which the image was generated may be determined using the orientation data generated by sensors 914 and known angle differences between the sensors and the optical axis of the camera. The images and associated location and orientation data may be processed as the plurality of images in a manner similar to that described above with respect to FIG. 8.

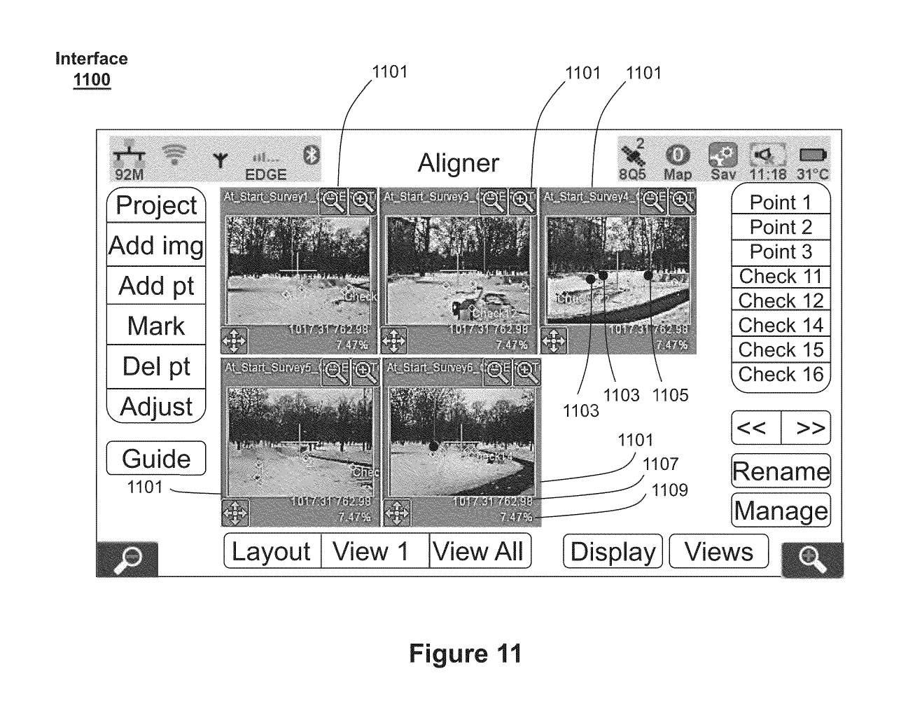

FIG. 11 illustrates an exemplary user interface 1100 that may be displayed on display 912 of GNSS device 900. User interface 1100 may include any number of images 1101 generated by GNSS device 900. User interface 1100 may further include any number of point identifiers 1103 that identify points (e.g., objects of interest) having unknown locations within each image and any number of check point identifiers 1105 that identify points having known locations within each image. Each point may be further associated with a unique identifier (e.g., a number, name, etc.), where similarly identified points within the different images may correspond to the same physical object or location. In some examples, the check points may be used to evaluate the accuracy of the coordinates of the unknown points (e.g., determined using process 800) by comparing the determined coordinates of the unknown points with the known coordinates of the check points. User interface 1100 may further include cursor coordinates 1107 and zoom level percent 1109 for each image 1101.

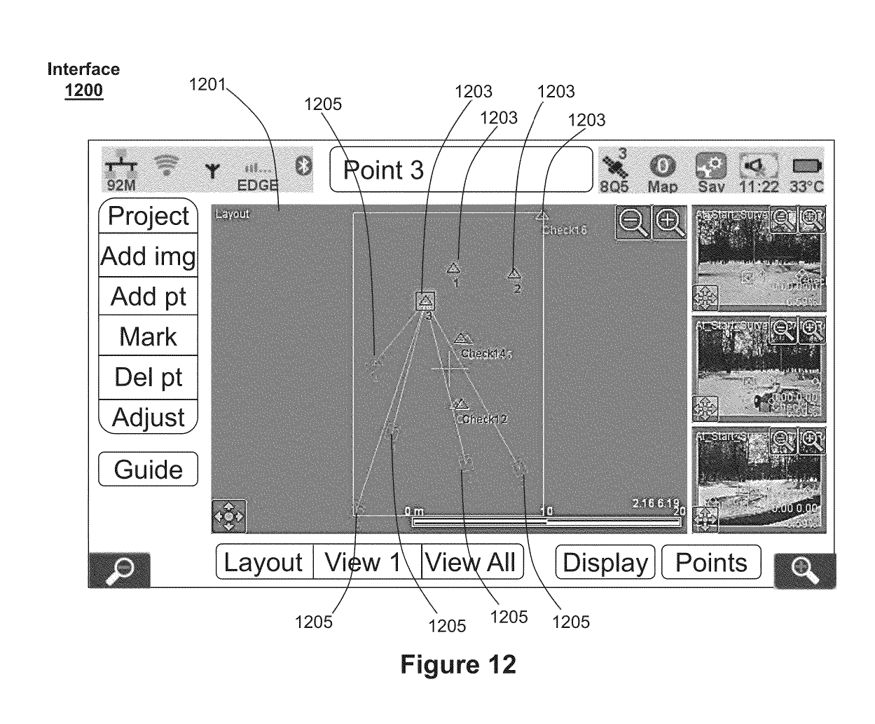

FIG. 12 illustrates another exemplary user interface 1200 that may be displayed on display 912 of GNSS device 900. User interface 1200 may include a scene layout 1201 illustrating an overhead view of the locations of the camera when the images were generated (represented by camera identifiers 1205) and the points (e.g., objects of interest) being surveyed (represented by point identifiers 1203). The positions of point identifiers 1203 and camera identifiers 1205 within scene layout 1201 may correspond to the geographical locations of the points and locations of the camera when the images were generated, respectively. When a particular point identifier 1203 is selected, a line may be displayed connecting the selected point identifier 1203 and the camera identifiers 1205 representing images in which the point corresponding to the selected point identifier 1203 is visible. This allows the user to view the quality and quantity of images available for determining the location of the point corresponding to the selected point identifier 1203. Similar to interface 1100, each point and camera location may be associated with a unique identifier (e.g., a number, name, etc.).

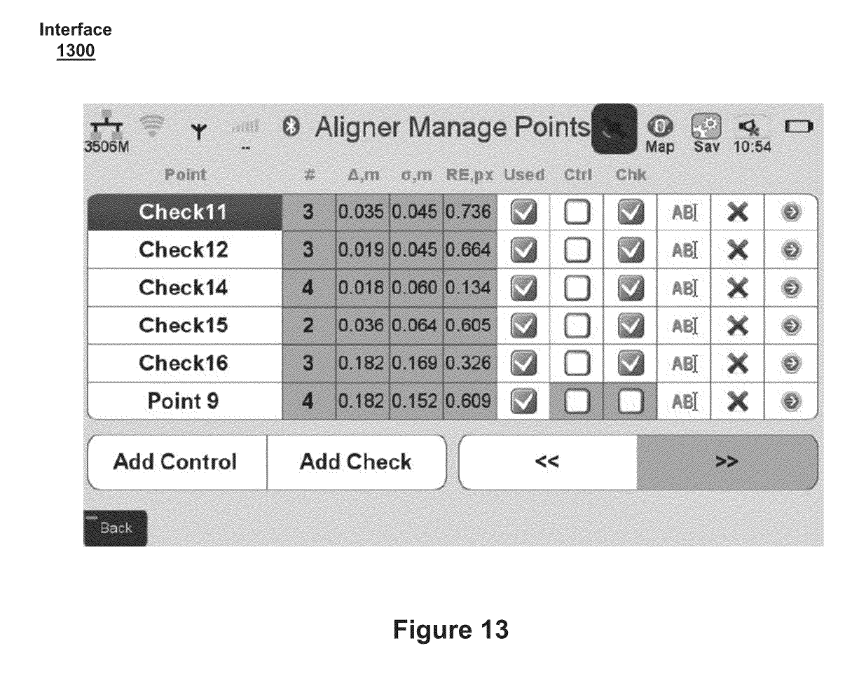

FIG. 13 illustrates another exemplary user interface 1300 that may be displayed on display 912 of GNSS device 900. User interface 1300 may display an accuracy report for the results of a scene calculation performed using process 800. In the illustrated example, user interface 1300 includes a first column containing point identifiers, a second column indicating the number of images in which the points were visible, a third column indicating actual residual values between instrumentally measured and computed point coordinates (for points with known coordinates), a fourth column indicating estimated calculated coordinates accuracy, a fifth column indicating reprojection error (e.g., discrepancy between actual pixel coordinates and those calculated using process 800), and additional columns for controls for point management.

It will be appreciated that, for clarity purposes, the above description has described embodiments with reference to different functional units and processors. However, it will be apparent that any suitable distribution of functionality between different functional units, processors, or domains may be used. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Furthermore, although individually listed, a plurality of means, elements, or method steps may be implemented by, for example, a single unit or processor. Additionally, although individual features may be included in different claims, these may possibly be advantageously combined, and the inclusion in different claims does not imply that a combination of features is not feasible or advantageous. Also, the inclusion of a feature in one category of claims does not imply a limitation to this category, but rather the feature may be equally applicable to other claim categories, as appropriate.

Although a feature may appear to be described in connection with a particular embodiment, one skilled in the art would recognize that various features of the described embodiments may be combined. Moreover, aspects described in connection with an embodiment may stand alone.

What is claimed is:

1. A computer-implemented method for performing aerial photography, the method comprising:
generating a path to be followed by an aerial vehicle, wherein generating the path to be followed comprises:
determining a first offset location that is a lateral distance and a vertical distance from a first location of a ground vehicle; and
storing the first offset location as a first point in the path to be followed;
traversing, by the aerial vehicle, the path to be followed; and
generating, by the aerial vehicle, a plurality of images while traversing the path to be followed.

2. The method of claim 1, wherein generating the path to be followed further comprises:
determining a second offset location that is the lateral distance and the vertical distance from the a second location of the ground vehicle; and
storing the second offset location as a second point in the path to be followed, wherein the second point is arranged within the path to be traversed after the first point.

3. The method of claim 2, wherein the first location of the ground vehicle represents a location of the ground vehicle at a first time, and wherein the second location of the ground vehicle represents a location of the ground vehicle at a second time, the second time occurring after the first time.

4. The method of claim 2 wherein traversing, by the aerial vehicle, the path to be followed comprises traveling to the first point in the path and subsequently traveling to the second point in the path.

5. The method of claim 4, wherein traveling to the first point in the path and subsequently traveling to the second point in the path is performed automatically without user input.

6. The method of claim 1, wherein the method further comprises performing photogrammetry of an object of interest using at least a portion of the plurality of images.

7. The method of claim 1, wherein the first location of the ground vehicle is wirelessly received by the aerial vehicle from the ground vehicle.

8. The method of claim 1, wherein the first location of the ground vehicle is determined by:
generating, by the aerial vehicle, an image;
identifying a marker within the image; and
determining a location of the marker based on a location of the aerial vehicle, an orientation of the aerial vehicle, a size of the marker within the image, and a position of the marker within the image, wherein the determined location of the marker is the first location of the ground vehicle.

9. The method of claim 1, further comprising, periodically:
receiving a new location of the ground vehicle;
determining a new offset location that is the lateral distance and the vertical distance from the new location of the ground vehicle; and
storing the new offset location as a new point in the path to be followed.

10. The method of claim 1, further comprising, periodically:
generating a new image;
identifying a marker within the new image;
determining a new location of the marker based on a location of the aerial vehicle, an orientation of the aerial vehicle, a size of the marker within the new image, and a position of the marker within the new image;
determining a new offset location that is the lateral distance and the vertical distance from the new location of the marker; and
storing the new offset location as a new point in the path to be followed.

11. An aerial vehicle for performing aerial photography, the aerial vehicle comprising:
a camera;
a propulsion and steering system;
a non-transitory computer-readable storage medium comprising computer instructions for:
generating a path to be followed by an aerial vehicle, wherein generating the path to be followed comprises:
determining a first offset location that is a lateral distance and a vertical distance from a first location of a ground vehicle; and
storing the first offset location as a first point in the path to be followed;
controlling the propulsion and steering system to cause the aerial vehicle to traverse path to be followed; and
controlling the camera to generate a plurality of images while the aerial vehicle is traversing the path to be followed; and
a processor operatively couple to the camera, the propulsion and steering system, and the non-transitory computer-readable storage medium, wherein the processor is capable of executing the computer instructions.

12. The aerial vehicle of claim 11, wherein generating the path to be followed further comprises:
determining a second offset location that is the lateral distance and the vertical distance from the a second location of the ground vehicle; and
storing the second offset location as a second point in the path to be followed, wherein the second point is arranged within the path to be traversed after the first point.

13. The aerial vehicle of claim 12, wherein the first location of the ground vehicle represents a location of the ground vehicle at a first time, and wherein the second location of the ground vehicle represents a location of the ground vehicle at a second time, the second time occurring after the first time.

14. The aerial vehicle of claim 12, wherein controlling the propulsion and steering system to cause the aerial vehicle to traverse path to be followed comprises controlling the propulsion and steering system to cause the aerial vehicle to travel to the first point in the path and subsequently travel to the second point in the path.

15. The aerial vehicle of claim 14, wherein traveling to the first point in the path and subsequently traveling to the second point in the path is performed automatically without user input.

16. The aerial vehicle of claim 11, wherein the non-transitory computer-readable storage medium further comprises instructions for performing photogrammetry of an object of interest using at least a portion of the plurality of images.

17. The aerial vehicle of claim 11, wherein the aerial vehicle further comprises a GNSS receiver, and wherein the non-transitory computer-readable storage medium further comprises computer instructions for determining the first location of the ground vehicle by:
causing the camera to generate an image;
identifying a marker within the image; and
determining a location of the marker based on a location of the aerial vehicle determined using the GNSS receiver, an orientation of the aerial vehicle, a size of the marker within the image, and a position of the marker within the image, wherein the determined location of the marker is the first location of the ground vehicle.

18. The aerial vehicle of claim 11, wherein the aerial vehicle further comprises a wireless communication system for wirelessly receiving the first location of the ground vehicle from the ground vehicle.

19. The aerial vehicle of claim 17 wherein the non-transitory computer-readable storage medium further comprises computer instructions for periodically:
receiving a new location of the ground vehicle;
determining a new offset location that is the lateral distance and the vertical distance from the new location of the ground vehicle; and
storing the new offset location as a new point in the path to be followed.

20. The aerial vehicle of claim 11, wherein the non-transitory computer-readable storage medium further comprises computer instructions for periodically:
causing the camera to generate a new image;
identifying a marker within the new image;
determining a new location of the marker based on a location of the aerial vehicle, an orientation of the aerial vehicle, a size of the marker within the new image, and a position of the marker within the new image;
determining a new offset location that is the lateral distance and the vertical distance from the new location of the marker; and
storing the new offset location as a new point in the path to be followed.
